(19) United States
(12) Patent Application Publication
(10) Pub. No.: US 2014/0009947 A1
(43) Pub. Date: Jan. 9, 2014

(54) PANEL LIGHT FRAME

(71) Applicant: CHIN-LIN CHEN, Tainan City (TW)

(72) Inventor: CHIN-LIN CHEN, Tainan City (TW)

(73) Assignee: KENMOS TECHNOLOGY CO., LTD., Tainan City (TW)

(21) Appl. No.: 13/541,877

(22) Filed: Jul. 5, 2012

(51) Int. Cl. F21V 21/00

(52) U.S. Cl. 362/382

(57) ABSTRACT

A panel light frame is revealed. Each of two ends of a second frame strip is inserted between a pressing end surface and a top end surface of a first frame strip. A front edge of the second frame strip is leaning against the pressing end surface of the first frame strip and an outer end surface of the second frame strip is leaning against the top end surface of the first strip. Thus connection end surfaces of the first and the second frame strip are connected to and positioned by each other. Thereby light from light emitting modules is shielded by the connection end surfaces for preventing light leakage. Moreover, the first and the second frame strips are against, supported and positioned by each other and this makes the connection of the frame strips more convenient. The panel light frame has higher practical value.

### BACKGROUND OF THE INVENTION

1. Field of the Invention

The present invention relates to a panel light frame, especially to a panel light frame that includes a first frame strip and a second frame strip for preventing light emitted from light emitting modules from leaking out thereof. Moreover, a position limit function is provided for convenience of assembly while connecting the first frame strip and the second frame strip. Thus the panel light frame is of higher practical value.

2. Description of Related Art

Refer to FIG. 9, a general panel light frame 2 available now includes a plurality of frame strips 21. Each frame strip 21 is concavely disposed with a mounting slot 211 used for receiving light sources. A plurality set of connection holes 212 are arranged at intervals at an inner side of the frame strip 21. An inclined connection end surface 213 is set on each of two ends of the frame strip 21. Moreover, a connection end angle 214 of 45 degrees is formed on each of two sides of the connection end surface 213. Thereby the two frame strips 21 of the frame 2 are leaning against each other by their connection end surface 213 firstly. Then the connection holes 212 of the two frame strips 21 are connected and positioned by connecting pieces and fasteners. Thus light is emitted from the light sources in the mounting slot 211 of each frame strip 21 of the frame 2.

However, although the above panel light frame 2 performs the expected functions and light is emitted from the light sources in the mounting slot 211 of each frame strip 21, the structure of the panel light frame 2 still has following shortcomings while in use.
1. During manufacturing processes of the frame strip 21, a clamping device is required to clamp and fix the connection end angle 214 on each of two ends thereof for performing electroplating. The clamping causes uneven thickness on electroplating at the connection end angle 214. There is no shielding member designed on the connection end surface 213 on each of two ends of the frame strip 21. Thus after the assembly of the frame strips 21, light emitted from the light sources will pass through the uneven electroplating to leak out.
2. The leaning and assembling of the frame strips 21 are difficult because that the connection end surface 213 is inclined, the connection end angle 214 is of 45 degrees and there is not position limit device designed.

Moreover, the frame strips 21 are easy to get sliding during the movement and shipment of the frame 2. The connection between the adjacent connection end angles 214 is not tight and secure. As shown in FIG. 10, the connection end surfaces 213 and the connection end angles 214 are staggered. Thus the frame strips 21 are easy to get scratched or deformed due to impacts. Moreover, the unsecured connection also allows light emitted from the light sources o leak out from two ends of the frame strip 21.

Thus there is room for improvement and a need to provide a novel panel light frame that overcomes the shortcomings mentioned above.

### SUMMARY OF THE INVENTION

Therefore it is a primary object of the present invention to provide a panel light frame in which no light leakage occurs. The assembly and connection of a first frame strip and a second frame strip is more convenient. Thus the panel light frame is of higher practical value.

In order to achieve the above object, a panel light frame of the present invention includes a first frame strip, and a second frame strip. Each of two ends of the second frame strip is inserted between a pressing end surface and a top end surface of the first frame strip. A front edge of the second frame strip is leaning against the pressing end surface of the first frame strip and an outer end surface of the second frame strip is leaning against the top end surface of the first strip. A connection end surface of the first frame strip and a connection end surface of the second frame strip are against each other to be connected and positioned. Thus the first frame strip and the second frame strip are connected to and fixed by each other. Thereby light from light emitting modules is shielded by the connection end surfaces on two ends of the first and the second frame strips for preventing light leakage. Moreover, the first frame strip and the second frame strip are leaning against, supported and positioned by each other because that the front edge of the second frame strip is leaning against the pressing end surface of the first frame strip and the outer end surface of the second frame strip is leaning against the top end surface of the first strip. Thus the assembly and connection of the frame strips is more convenient. The panel light frame has higher practical value.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an explosive view showing structure of an embodiment according to the present invention;

FIG. 2 is an assembly view of an embodiment according to the present invention;

FIG. 3 is a partial front view of an assembled embodiment according to the present invention;

FIG. 4 is a partial rear view of an assembled embodiment according to the present invention;

FIG. 5 is a schematic drawing showing a cross section view taken along line A-A of the assembled embodiment in FIG. 3;

FIG. 6 is an explosive view of another embodiment according to the present invention;

FIG. 7 is an explosive view of a further embodiment according to the present invention;

FIG. 8 is an explosive view of a further embodiment according to the present invention;

FIG. 9 is an explosive view of a prior art;

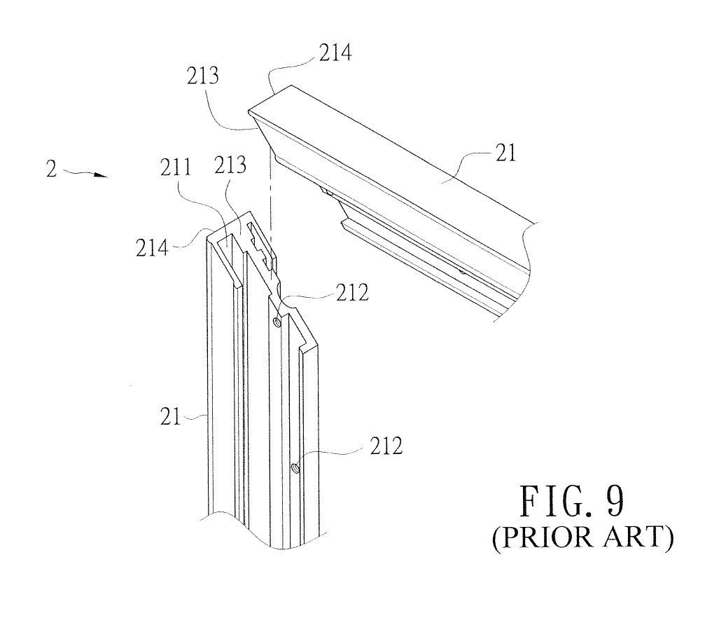

FIG. 10 is a schematic drawing showing staggered connection end angles of a prior art.

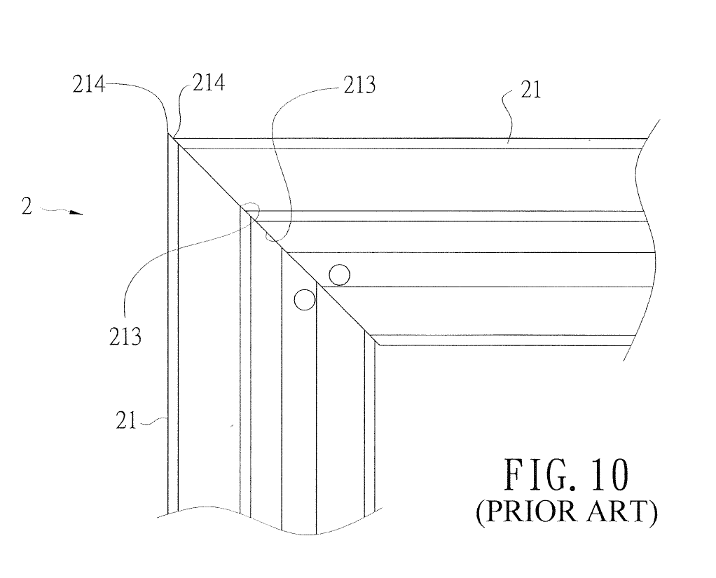

### DETAILED DESCRIPTION OF THE PREFERRED EMBODIMENT

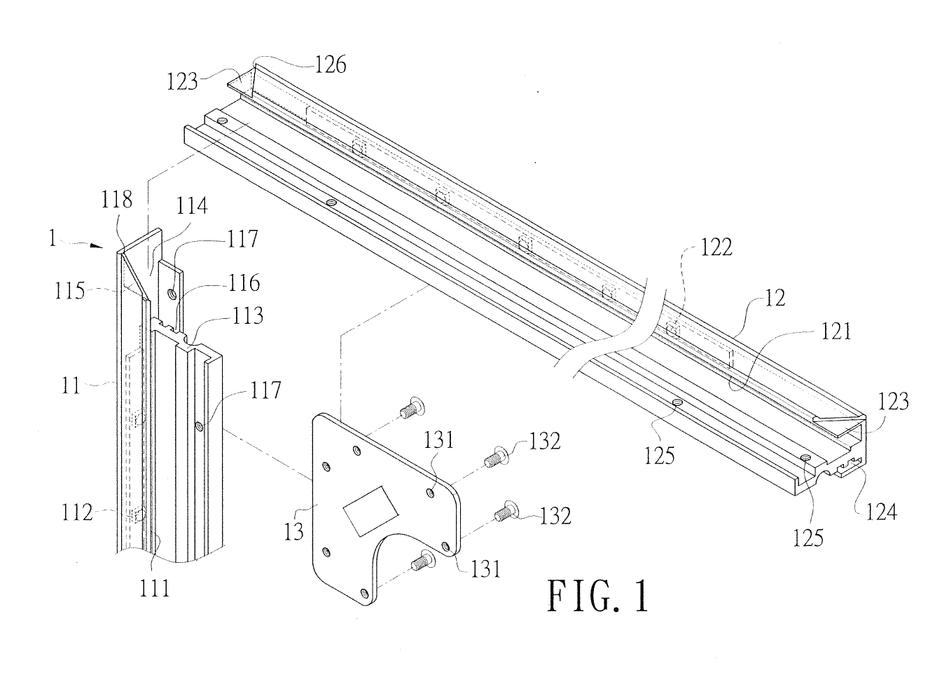

Refer to FIG. 1, an embodiment of the present invention mainly includes a frame 1 composed of a first frame strip 11, a second frame strip 12 corresponding to the first frame strip 11, and an assembly piece 13 connected and positioned between the first frame strip 11 and the second frame strip 12.

The first frame strip 11 is disposed concavely with a mounting slot 111 for receiving light emitting modules 112 therein. A pressing end surface 113 is located on an inner side of two ends of the first frame strip 11 while a top end surface 114 is formed on an outer side of the pressing end surface 113. And a connection end surface 115 is arranged at an inner surface of a side wall of each of two ends of the first frame strip 11. An insertion slot 116 is concavely disposed on an outer and rear side of the first frame strip 11 and a plurality of connection holes 117 is arranged at the inner side of the first frame strip 11. A connection end angle 118 is formed on top and bottom ends of the first frame strip 11 respectively.

The second frame strip 12 also includes a concave mounting slot 121 for receiving light emitting modules 122 therein. A side wall of the second frame strip 12 corresponding to the connection end surface 115 of the first frame strip 11 is disposed with a connection end surface 123. Moreover, an insertion slot 124 is concavely disposed on the second frame strip 12 near the rear end of the second frame strip 12 and a plurality of connection holes 125 is arranged near the front side of the second frame strip 12. A connection end angle 126 corresponding to the connection end angle 118 of the first frame strip 11 is formed on each of two ends of the second frame strip 12. The connection end angle 118 of the first frame strip 11 is different from the connection end angle 126 of the second frame strip 12. The connection end angle 126 and the connection end angle 118 are connected and assembled to form a right-angle.

The assembly piece 13 is mounted in the insertion slot 116 of the first frame strip 11 and the insertion slot 124 of the second frame strip 12. The assembly piece 13 is disposed with a plurality of assembly holes 131 respectively corresponding to the connection holes 117, 125 of the first and the second frame strips 11, 12. The assembly holes 131 and the connection holes 117, 125 are assembled and fixed by a plurality of fasteners 132.

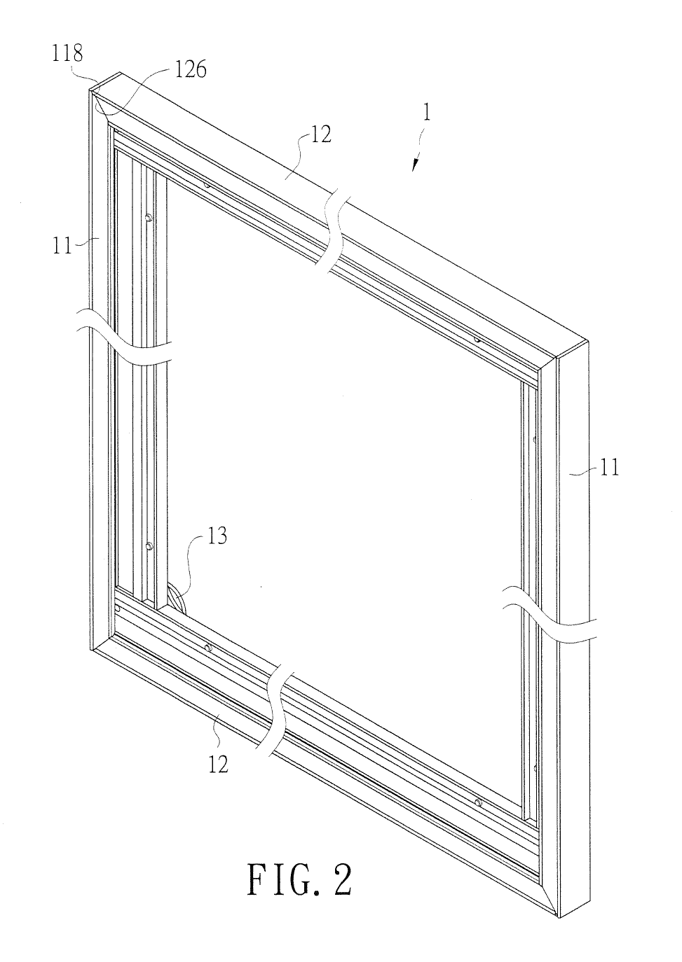

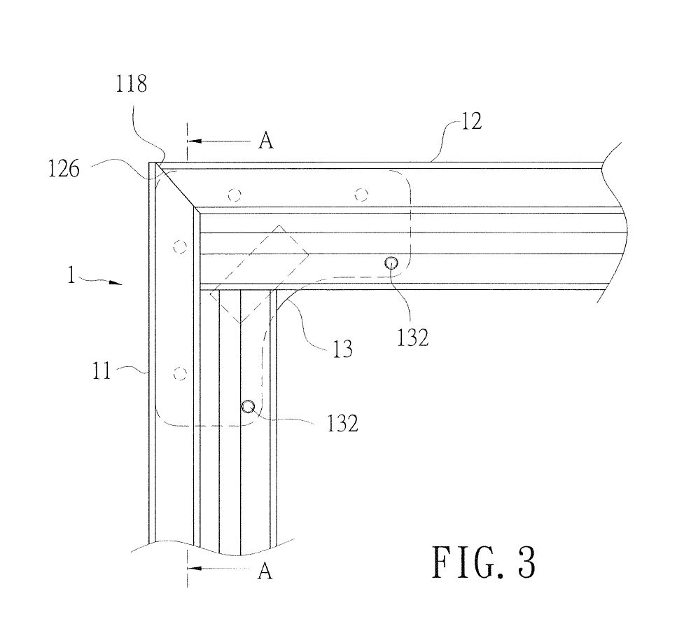

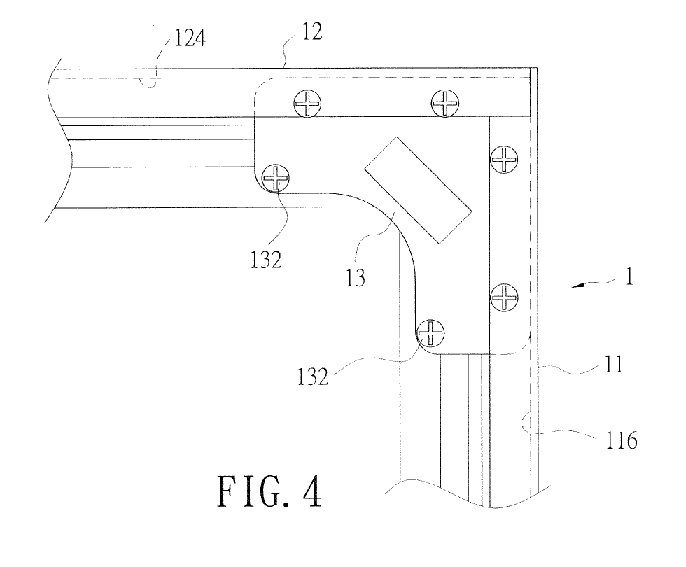

While being assembled, refer to FIG. 2, FIG. 3, and FIG. 4, each of the two ends of the second frame strip 12 is inserted between the pressing end surface 113 and the top end surface 114 of the first frame strip 11. The front edge of the second frame strip 12 is leaning against the pressing end surface 113 of the first frame strip 11 while the outer end surface of the second frame strip 12 is leaning against the top end surface 114 of the first strip 11. Thus the first frame strip 11 and the second frame strip 12 are against, supported and positioned by each other. At the same time, the connection end surface 115 of the first frame strip 11 and the connection end surface 123 of the second frame strip 12 are against each other to be connected and positioned. Moreover, the connection end angle 118 of the first frame strip 11 and the connection end angle 126 of the second frame strip 12 are connected to each other correspondingly so as to form a right-angle.

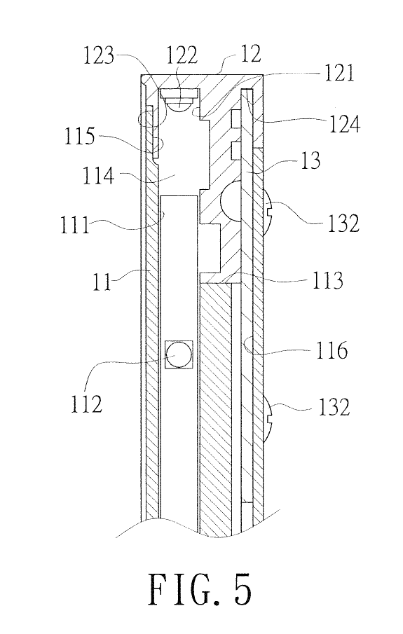

Then the assembly piece 13 is inserted into the insertion slots 116, 124 of the first and the second frame strips 11, 12. Next each assembly hole 131 of the assembly piece 13 is connected to and fixed with the corresponding connection holes 117, 125 of the first and the second frame strips 11, 12 by the fastener 132. Refer to FIG. 5, the first frame strip 11 and the second frame strip 12 of the frame 1 are connected to and positioned by each other. Thus the connection end surface 115 of the first frame strip 11 and the connection end surface 123 of the second frame strip 12 are against, connected to and positioned by each other. At the same time, the connection end angles 118, 126 of the first and the second frame strips 11, 12 are connected to each other correspondingly. Therefore light emitted from the light emitting modules 112, 122 is shielded by the connection end surfaces 115, 123 on two ends of the first and the second frame strips 11, 12 and there is no light leakage.

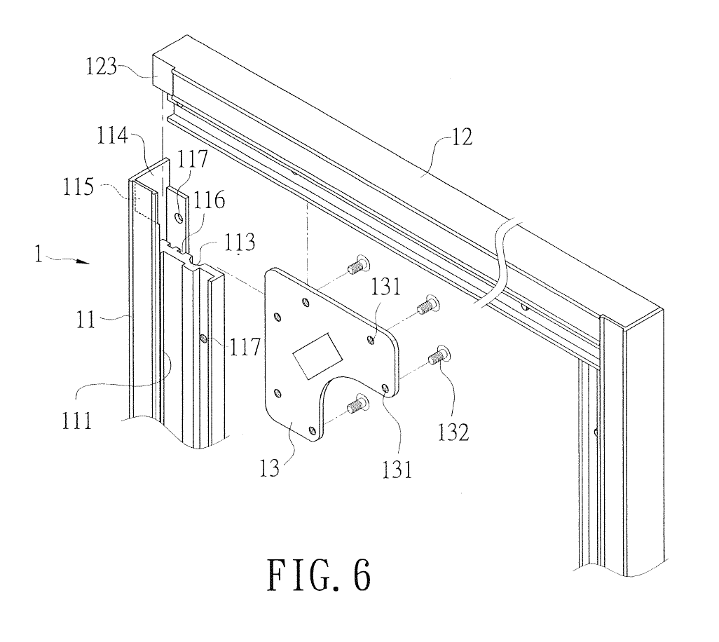

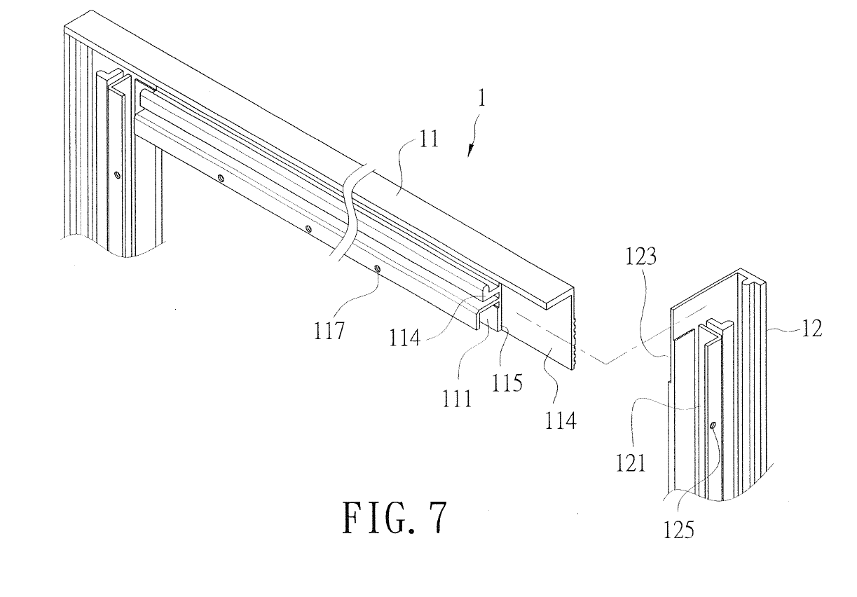

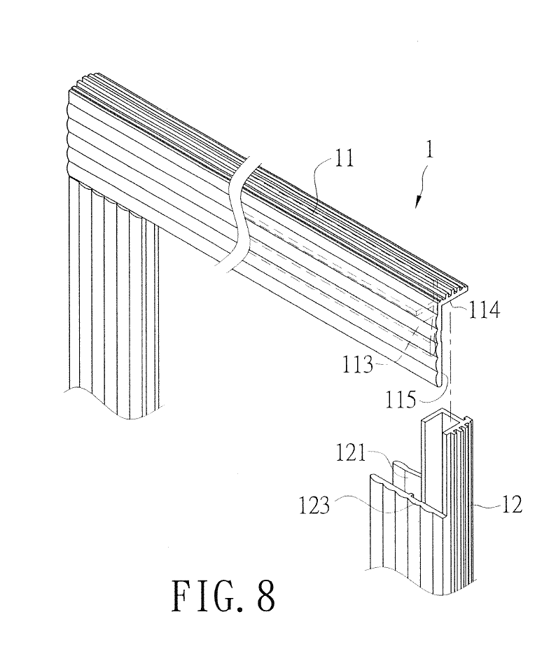

Furthermore, the first frame strip 11 is arranged vertically and the second frame strip 12 is disposed horizontally in some embodiments of the present invention, as shown in the FIG. 1 and FIG. 6. In some other embodiments shown in FIG. 7 and FIG. 8, the first frame strip 11 is set horizontally while the second frame strip 12 is arranged vertically.

In addition, the connection end surface 115 of the first frame strip 11 and the connection end surface 123 of the second frame strip 12 are connected to form a miter joint, as shown in the FIG. 1. Refer to FIG. 6, FIG. 7 and FIG. 8, in some other embodiments, the connection end surface 115 of the first frame strip 11 and the connection end surface 123 of the second frame strip 12 are both rectangular and corresponding to each other.

In summary, the present invention has following advantages compared with the structure available now:
1. While being assembled, the connection end surface of the first frame strip and the connection end surface of the second frame strip are leaning against, connected to and positioned by each other. The light emitted from the light emitting modules are shielded by the connection end surfaces on two ends of the first frame strip and two ends of the second frame strip so as to prevent light leakage.
2. The front edge of the second frame strip is leaning against the pressing end surface of the first frame strip while the outer end surface of the second frame strip is leaning against the top end surface of the first strip. Thus the first frame strip and the second frame strip are against, supported and positioned by each other. The assembly and the connection are more convenient.
3. The connection end angle of the first frame strip and the connection end angle of the second frame strip are connected to form a right-angle. Moreover, the two connection end angles are different from each other so that the positioning is convenient while being connected to each other. There is no sliding and stagger. The connection between the two connection end angles is flat without scratches or deformation caused by bumps.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A panel light frame comprising two first frame strips and two second frame strips connected and positioned by each other correspondingly;
wherein the first frame strip is disposed concavely with a mounting slot for receiving light emitting modules therein; a pressing end surface is located on an inner side of two ends of the first frame strip while a top end surface is formed on an outer side of the pressing end surface; and a connection end surface is arranged at an inner surface of a side wall of each of two ends of the first frame strip;
the second frame strip includes a concave mounting slot for receiving light emitting modules therein; a side wall of the second frame strip corresponding to the connection end surface of the first frame strip is disposed with a connection end surface; each of two ends of the second frame strip is inserted between the pressing end surface and the top end surface of the first frame strip; a front edge of the second frame strip is leaning against the pressing end surface of the first frame strip and an outer end surface of the second frame strip is leaning against the top end surface of the first strip; and the connection end surface of the first frame strip and the connection end surface of the second frame strip are connected to, leaning against and positioned by each other.

2. The device as claimed in claim 1, wherein the connection end surface of the first frame strip and the connection end surface of the second frame strip are connected to form a miter joint.

3. The device as claimed in claim 1, wherein the connection end surface of the first frame strip and the connection end surface of the second frame strip are both rectangular and corresponding to each other.

4. The device as claimed in claim 1, wherein the first frame strip is disposed vertically and the second frame strip is arranged horizontally.

5. The device as claimed in claim 1, wherein the first frame strip is set horizontally while the second frame strip is arranged vertically.

6. A panel light frame comprising two first frame strips and two second frame strips connected and positioned by each other correspondingly;
wherein the first frame strip is disposed concavely with a mounting slot for receiving light emitting modules therein; a pressing end surface is located on an inner side of two ends of the first frame strip while a top end surface is formed on an outer side of the pressing end surface; and a connection end angle is formed on each of two ends of the first frame strip respectively;
the second frame strip includes a concave mounting slot for receiving light emitting modules therein; a connection end angle corresponding to the connection end angle of the first frame strip is formed on each of two ends of the second frame strip; the connection end angle of the first frame strip is different from the connection end angle of the second frame strip; each of two ends of the second frame strip is inserted between the pressing end surface and the top end surface of the first frame strip; a front edge of the second frame strip is leaning against the pressing end surface of the first frame strip and an outer end surface of the second frame strip is leaning against the top end surface of the first strip; the connection end angle of the first frame strip and the connection end angle of the second frame strip are connected and assembled to form a right-angle.

7. The device as claimed in claim 6, wherein the first frame strip is disposed vertically and the second frame strip is arranged horizontally.

8. The device as claimed in claim 6, wherein the first frame strip is arranged horizontally and the second frame strip is disposed vertically.
